(19) United States
(12) Patent Application Publication
(10) Pub. No.: US 2023/0063802 A1
(43) Pub. Date: Mar. 2, 2023

(54) SYSTEMS AND METHODS FOR TIME-DEPENDENT HYPERLINK PRESENTATION

(71) Applicant: Rock Cube Holdings LLC, Syracuse, NY (US)

(72) Inventors: Michael Gursha, Chappaqua, NY (US); Douglas Gursha, Chappaqua, NY (US)

(21) Appl. No.: 17/822,675

(22) Filed: Aug. 26, 2022

Related U.S. Application Data
(60) Provisional application No. 63/260,680, filed on Aug. 27, 2021.

(51) Int. Cl. G06F 16/955; G06F 16/93; G06F 16/951; G06F 16/958

(52) U.S. Cl. CPC G06F 16/9558; G06F 16/94; G06F 16/951; G06F 16/958

(57) ABSTRACT

A method for automatically inserting hyperlinks is provided. In one example, the method includes monitoring a user's interaction with a document via algorithms of a hyperlink generation engine implemented at a processor of a client device, and identifying a structural element in the document of interest to the user, based on the user's interaction and a set of rules input to the hyperlink generation engine. The structural element may be automatically modified to include a first hyperlink and displayed in the document at a display device.

### CROSS REFERENCE TO RELATED APPLICATIONS

The present application claims priority to U.S. Provisional Application No. 63/260,680 entitled “SYSTEMS AND METHODS FOR TIME-DEPENDENT HYPERLINK PRESENTATION”, and filed on Aug. 27, 2021. The entire contents of the above-identified applications are hereby incorporated by reference for all purposes.

### FIELD

The disclosure relates generally to automatic display of hyperlinks on a webpage.

### BACKGROUND

Rising demand for readily accessible information has driven an increase in publicly available media, such as Internet-based content. Users may rely on websites hosted on the Internet where the websites may be used to consolidate information on a specific topic or range of topics and, in some examples, to find other websites of related content. The websites may include one or more webpages located under a common domain name, and navigation between the webpages of the website, as well as between the website and external websites, may be provided by hyperlinks.

A hyperlink is an HTML element, otherwise known as an anchor, that provides a link from a current electronic document, e.g., as displayed at the website, to other web pages, files, email addresses, locations within the same document, or any other items a URL may address. The new document may be another webpage within the website or a webpage of an external website, e.g., a website belonging to a different domain name. The hyperlink may be located at a relevant point in the document, presented with content indicating the hyperlink's destination that represents a topic of the linked document. Hyperlinks may also contain other forms of content besides text including HTML elements such as icons, images, and containers. For a website with few pages and a relatively small amount of content, the hyperlinks may be manually inserted (e.g., entered into a coding of the webpage) or may be automatically generated, e.g., using an algorithm for hyperlink generation, based on one or more keywords.

For a large-content website having numerous webpages covering large quantities of information, however, manual entry may be laborious, inefficient and may lead to errors during entry. Keyword-based hyperlink generation may cause a webpage to appear cluttered and render the website less visually appealing. An excessive presence of hyperlinks on a webpage may lessen a likelihood that a user will interact with the hyperlinks, e.g., the user may become desensitized to an abundance of hyperlinks. In contrast, sparse placement of hyperlinks in a webpage with a large amount of information may reduce a visibility of the hyperlinks and the hyperlinks may be lost in the webpage text. As such, finding the hyperlinks on the webpage may become difficult.

Furthermore, the hyperlinks are anchored to hypertext in the webpage according to predetermined topics of interest and do not change whether the hyperlinks are used or not. In some instances, depending on a presentation of the hyperlink, the topic of interest and additional resources provided by the hyperlink may be not indicated by its appearance and the user may not realize a relevancy of the hyperlink to a topic of interest. For the large-content website in particular, it may be challenging to ensure that the user is able to navigate the website and locate useful information in an efficient manner via the fixed hyperlinks.

In addition, a static characteristic of the hyperlinks may render the hyperlinks obsolete over time. For example, in a webpage with deep links, e.g., links to specific content, a likelihood of the hyperlinks being correctly linked may decrease with time. In some instances, a number of broken hyperlinks (e.g., linked to no longer existing or altered destinations) in the webpage may increase over time. A usefulness of the webpage for providing information may thus be degraded as a result of the broken hyperlinks. Manually updating the webpage, however, may be inconvenient and ineffective as maintaining an accuracy of the hyperlinks may demand time-consuming monitoring and searching for migrated target destinations or for new, suitable destinations.

It is desired to have systems and methods which customizable and adaptive generation and presentation of hyperlinks to provide more meaningful and useful pathways to locating information.

### SUMMARY

A hyperlink generating method is provided to automatically insert hyperlinks. The method includes, responsive to user interaction with portion of a document for a first threshold period of time, adding a first hyperlink at the portion of the document, the first hyperlink coupled to a destination providing information relevant to the portion of the document. In this way, hyperlinks may be strategically positioned within the document to increase a visibility of the hyperlinks and to allow a user to obtain relevant information efficiently.

In one embodiment, a hyperlink generation engine may be implemented to adjust a presentation of hyperlinks at a document, such as a webpage, according to a user's interaction with the webpage. The hyperlink generation engine may be configured to apply a time-dependent aspect to the presentation of the hyperlinks such that the hyperlinks may appear and/or disappear depending on user behavior. As a result, the hyperlinks may attract the user's attention more effectively and may allow customizable generation of the hyperlinks. Furthermore, the hyperlinks may be updated frequently, thereby reducing a likelihood of broken or obsolete links.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The disclosure may be better understood from reading the following description of non-limiting embodiments, with reference to the attached drawings, wherein below:

FIG. 1 shows a block diagram of an example hyperlink generation system configured to automatically insert hyperlinks into a document based on user preference via a dynamic hyperlink generation engine.

FIG. 2 shows a block diagram of an example networked computing system for automatically generating hyperlinks via the dynamic hyperlink generation engine.

FIG. 3A shows an example of hyperlinks located in a first section of a webpage.

FIG. 3B shows an example of an appearance of a new hyperlink in the first section of the webpage of FIG. 3A.

FIG. 3C shows an example of a disappearance of hyperlinks at a second section of the webpage of FIG. 3A.

FIG. 3D shows an example of an appearance of a pop-up hyperlink at the second section of the webpage.

FIG. 4 shows an example of an appearance of a timer at the second section of the webpage.

FIG. 5 shows an example of time-driven modification of an image at the second section of the webpage.

FIG. 6A shows an example of display of a first hyperlink of a series of time-driven hyperlinks at the second section of the webpage.

FIG. 6B shows an example of display of a second hyperlink of the series of time-driven hyperlinks at the second section of the webpage.

FIG. 7 shows an example of a method for automatically generating time-released hyperlinks based on user engagement with an electronic document.

FIG. 8 shows an example of a method for automatically hiding or removing hyperlinks according to an amount of time elapsed without user engagement.

### DETAILED DESCRIPTION

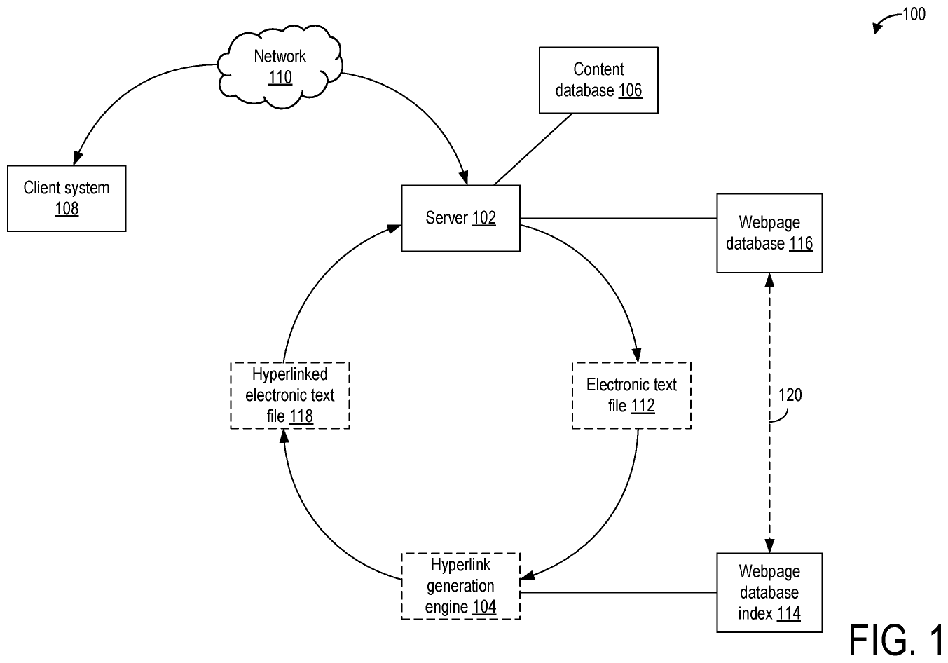

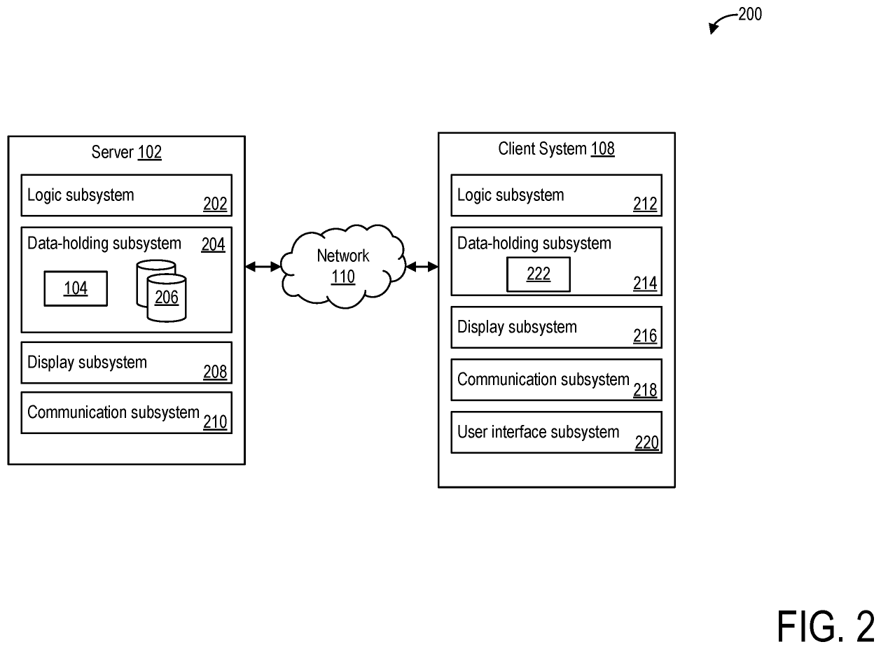

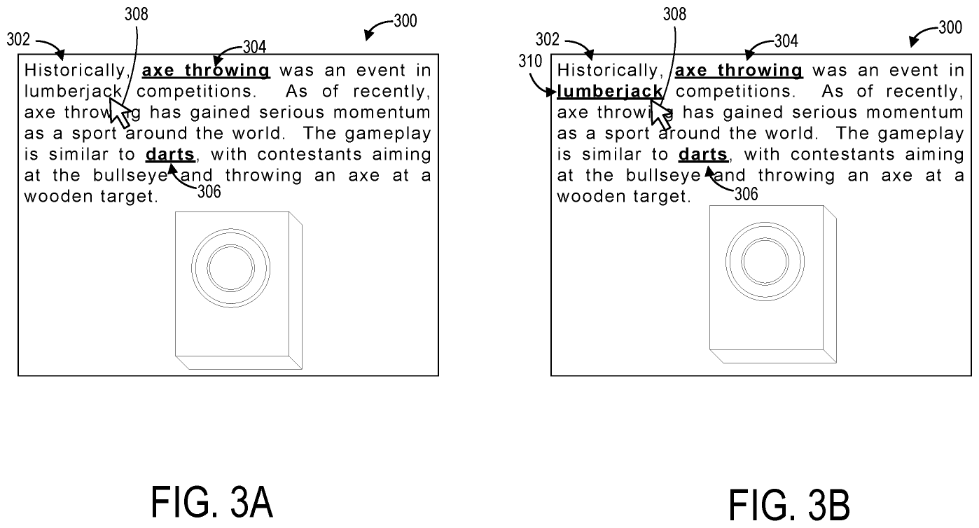

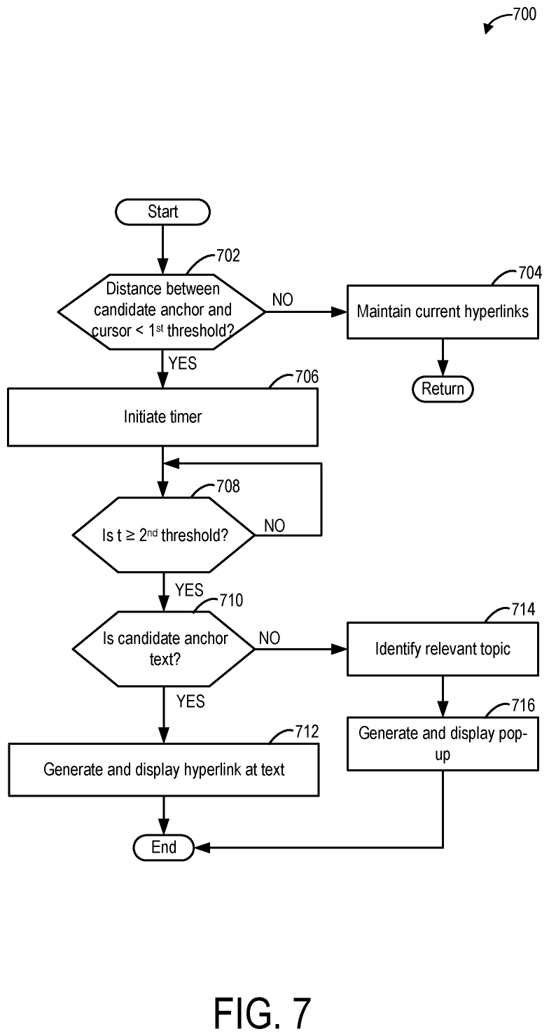

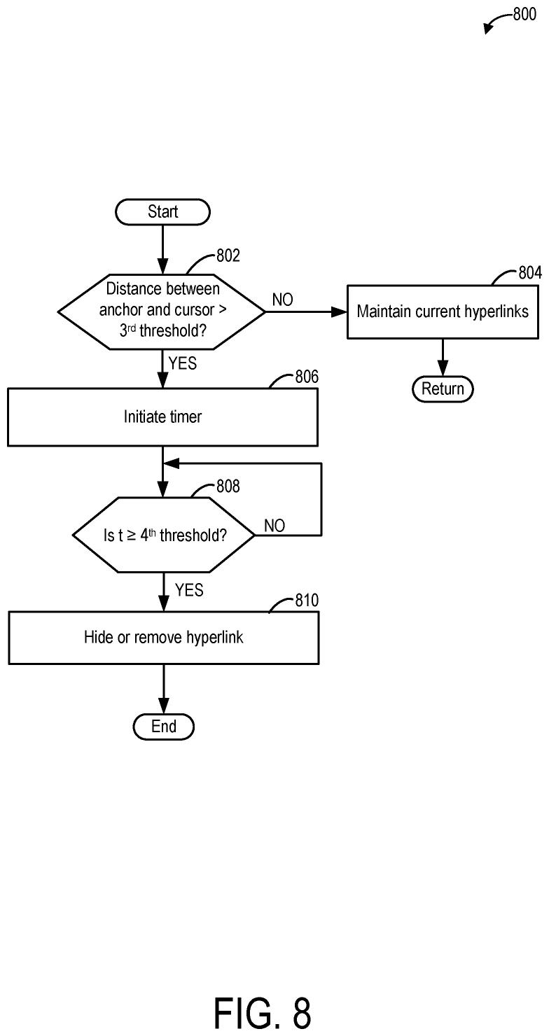

The following description relates to various embodiments of a hyperlink generation system. The hyperlink generation system may be configured with a hyperlink generation engine, as shown in FIG. 1, which may automatically modify a presentation of hyperlinks at a document, e.g., a webpage. The hyperlink generation system may be included in a networked computing system, as shown in FIG. 2, and may insert hyperlinks dynamically according to a user's interaction with the webpage. For example, the presentation of the hyperlinks may include a dependency on time which may moderate a visibility of the hyperlinks. More specifically, the hyperlinks may appear or disappear, e.g., be hidden from view or removed, in response to an indication of the user's interest with respect to how long the user engages with a particular section, phrase, image, etc., of the webpage content. It will be noted that hereafter, the hyperlinks may be described as being hidden which will be construed as being hidden from view, obscured, or no longer visible to the user. However, the hyperlink may still be present and embedded into the document in spite of disappearing, e.g., being hidden or no longer visible. In other words, disappearance of the hyperlinks indicates adjustment of the observed appearance of the hyperlinks which may be due to hiding or removal of the hyperlinks. Examples of an appearance/disappearance of one or more hyperlinks according to user behavior (e.g., based on positioning of a mouse cursor) with respect to interaction with elements of a webpage are depicted in FIGS. 3A-6B. Exemplary methods for adding and hiding hyperlinks according to time elapsed are shown in FIGS. 7 and 8, respectively.

It should be appreciated that although text hyperlinks are described herein, the systems and methods may be implemented for non-text anchored hyperlinks, such as hyperlinks configured as images, icons, HTML elements, etc. Anchors of the hyperlinks may be linked to different types of destinations, including webpages, both internal and external to a hyperlinked website, electronic documents, images, etc. The destinations may include a variety of mixed file types including document file types, image file types, video file types, music file types, PDFs, PNGs, JPGs, TXTs, spreadsheet file types, and the like.

Turning now to FIG. 1, a dynamic hyperlink generation system 100 is depicted as a block diagram therein. The dynamic hyperlink generation system (hereafter, system) 100 may automatically generate and insert hyperlinks into electronic text files in real-time according to user-defined rules with respect to content structure in the electronic text files, as described further below. The hyperlinks may associate digital content of various types to the electronic text files. In one example, the system may be configured to adjust a presentation of the hyperlinks on a time-dependent basis according to user behavior when a user is navigating a webpage constructed from the electronic text files.

User behavior may be determined according to manipulation of, for example, a mouse cursor across a visible screen (e.g., a portion visible on a display device such as a monitor) of the webpage. However, other examples of monitoring of user behavior may include swiping a touchscreen with a finger at a tablet or smart phone, pinching (with the user's fingers), zooming, and rotating of a screen of the smart (e.g., mobile) phone, interpretation of gestures at smart glasses, voice commands, etc. The presentation of the hyperlinks may be modified in response to predicted user interest in specific portions or structural elements of the webpage, where the structural elements may be terms, phrases, images, icons, or any other type of visible structure which may be present in the webpage.

The user interest may be predicted based on, as an example, a period of time the mouse cursor hovers over a structural element or portion of the webpage. For example, the user may scroll through the webpage but pause at a point of interest. As such, the mouse cursor may be positioned within a threshold distance of the point of interest which may be identified according to a type of structural element. As another example, scrolling through the webpage to bring a target region of the webpage into view at the screen of the smart phone may also indicate the user's interest in the target region. The user interest may be further predicted according to prior user interaction with the webpage. For example, the user interaction may include the user manipulating the mouse cursor to hover over a term repeated through the webpage or over text having a distinct appearance, such as bold typeface, underlining, etc. As another example, the user may use the mouse cursor to pause at a specific type of hyperlink, e.g., according to a common term, topic, type of image, etc. A pattern in user engagement may therefore be identified and used to estimate which structural elements of the webpage may have an increased likelihood of attracting user interest.

In some instances, the hyperlinks may be configured to appear at regions of the webpage without already existing hyperlinks after a period of time of user engagement elapses. In other instances, already existing hyperlinks identified to be of interest to the user may alter their appearance after a period of time if the user is not interacting with the hyperlinks. For example, the already existing hyperlinks may change color, flash, bounce, etc., if determined to be relevant to a topic the user has shown interest but has not yet engaged with.

In some examples, already existing hyperlinks may be configured to disappear if it is determined that the user is not interested in the already existing hyperlinks. For example, if the prior habits of the user indicate a lack of engagement with related elements of the webpage, the already existing hyperlinks may be hidden after a duration of time lapses without user interaction. As such, the hyperlinks may be in a launched state when visible and may be adjusted to an unlaunched state when hidden. In some instances, such as after prolonged duration of time without user engagement, or repeated navigation to the respective portion of the document without direct engagement, the hyperlinks may be removed. An organized, appealing appearance of the webpage, and hyperlinks embedded therein, may be therefore maintained. Further examples of the automated time-dependent modification of hyperlink presentation are provided further below, with reference to FIGS. 3A-6B.

The system 100 may include a server, e.g., a web server, 102, a hyperlink generation engine 104, and a content database 106. The hyperlink generation engine 104 may comprise one or more algorithms for tracking, scanning, and analyzing elements of an electronic document, including interaction of a user with the electronic document, and may draw linked content from the content database 106. The server 102 may be connected to a client system 108 by a network 110 (e.g., the Internet). It will be appreciated that while only one of each of the server 102, client system 108, network 110, etc., are shown, other examples may include more than one of each element of the system 100. Furthermore, alternate types of each element are possible. For example, the server 102 may be configured to host Internet activity or may be a server within a networked environment.

The server 102 may host data content, such as webpages with electronic text files. The electronic text files may be various types of text-based, computer readable files, including electronic documents, emails, new and other content-related articles, blog postings, etc. Each of the electronic text files may be formed of a Hyper-Text Markup Language (HTML) file, an Extensible Hyper-Text Markup Language (XHTML) file, or some other similar type of file. In one example, the electronic text files may be HTML files that are hosted and displayed on a website at the client system 108 by way of the server 102 and the network 110.

The electronic text files may be stored in the content database 106 to be retrievable upon demand when hyperlink creation is initiated. As an example, the server may retrieve an electronic text file 112 from the content database 106 and deliver the file 112 to the hyperlink generation engine 104. The hyperlink generation engine 104 may analyze and process the electronic text file 112 as described below, with reference to FIGS. 3A-8, to insert hyperlinks at target locations within the electronic text file 112. Each of the hyperlinks may be a bridge between a point in the electronic text file 112 in which the hyperlinks are embedded, e.g., an anchor of a hyperlink, and a source of related information in a different location from the anchor, e.g., a destination of the hyperlink.

Hyperlinks use an href attribute to specify a URL that the hyperlink links to. However, in other examples, other protocols besides HTTP-based URLs may be used that adhere to URL schemes supported by web browsers. Other hyperlink attributes include a target, e.g., where to display the linked URL in a webpage, and a Download attribute which prompts a user to save the linked URL to a computer instead of navigating to the URL. When adding hyperlinks to the electronic text file 112 from the content database 106, the hyperlink generation engine 104 may modify the electronic text file 112 by adding hyperlinks where determined. A resulting, modified version of the electronic text file 112 may be stored separately from the original file. The electronic text file 112 may be written and parsed in a variety of formats including plain text, Markdown, etc., and may eventually be converted into HTML by the server 102 before returning to the user.

The destination may be in a different section of the same electronic text file as the anchor, in a different electronic text file included in a same website formed of one or more electronic text files, or in a different website. The anchor of the hyperlink may be a visually distinct character, word, phrase, sentence, image, emoji, symbol, etc., in a webpage displayed to the user that allows the user to readily access additional information germane to a topic indicated by the anchor. Herein, the hyperlink may provide a link between a mutable anchor and a destination that is selected based on the anchor. For example, the anchor may be altered in real-time to accommodate an indicated topic of interest of the user which may be determined by monitoring the user's behavior as the user interacts with the webpage. The destination of the hyperlink may be similarly adjusted in real-time according to changes in the anchor, thereby increasing a likelihood that the user is able to rapidly obtain useful information.

The target locations of the electronic text file 112 may be used to query a webpage database index 114 to identify and locate websites that are relevant to the target locations. The webpage database index 114 may include indexed internal webpages, e.g., webpages included in a same website at which the electronic text file 112 is displayed, and/or external webpages, e.g., webpages included in a different website from the website at which the electronic text file 112 is displayed, or indexed versions of other types of electronic documents. The indexed webpages of the webpage database index 114 may be webpages identified with meta data related to the target locations of the electronic text file 112 and the hyperlink generation engine 104 may query the webpage database index 114 to locate webpages with metadata identifiers that correspond to the target locations.

Upon identifying the related webpages, the hyperlink generation engine 104 may dynamically generate a hyperlink at each of the target locations of the electronic text file 112, thereby linking the electronic text file 112 to an associated webpage at each hyperlink. In one example, the webpage database index 114 includes indexed versions of webpages that mirror the webpages stored in webpage database 116, the webpage database may be stored at the server 102. As webpages are added or removed from the webpage database 116, the webpage database index 114 may be updated accordingly via communication link 120. The hyperlink generation engine 104 is able to access addresses and locations of the webpages stored in webpage database 116 through communication link 120. The electronic text file 112 is transformed into a hyperlinked electronic text file 118 by the hyperlink generation engine 104 and made accessible to the client system 108 by returning the hyperlinked electronic text file 118 to the server 102. In some examples, the hyperlinked electronic text file 118 may be stored at the content database 106.

Details of the server 102 and the client system 108 are depicted in FIG. 2. FIG. 2 is a block diagram illustrating an example networked computing system 200, according to an embodiment. The networked computing system 200 includes the server 102 and the client system 108, communicatively coupled to the server 102 via the network 110. It should be appreciated that variations in the arrangement and type of components of the networked computing system 200 may be made without departing from the scope of the present disclosure. For example, the networked computing system 200 may include more than one client system 108 communicatively coupled to the server 102 via the network 110.

The server 102 includes a computing system configured to serve webpages upon request to one or more client systems such as the client system 108. Although the server 102 is depicted in FIG. 1 as a single device, in some embodiments the networked computing system 200 may include a plurality of servers 102 configured for distributed computing. In different embodiments, the server 102 may take the form of a mainframe computer, a server computer, a desktop computer, a laptop computer, a tablet computer, a network computing device, a mobile computing device, a microprocessor, and so on.

Server 102 includes a logic subsystem 202 and a data-holding subsystem 204. Logic subsystem 202 may include one or more physical devices configured to execute one or more instructions. For example, logic subsystem 202 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 202 may include one or more processors that are configured to execute software instructions. Additionally, or alternatively, the logic subsystem 202 may include one or more hardware or firmware logic machines configured to execute hardware or firmware instructions. Processors of the logic subsystem 202 may be single core or multi-core, and the programs executed thereon may be configured for parallel or distributed processing. The logic subsystem 202 may optionally include individual components that are distributed throughout two or more devices, which may be remotely located and/or configured for coordinated processing. One or more aspects of the logic subsystem 202 may be virtualized and executed by remotely accessible networked computing devices configured in a cloud computing configuration.

Data-holding subsystem 204 may include one or more physical devices configured to hold data and/or instructions executable by the logic subsystem 202 to implement the herein described methods and processes. When such methods and processes are implemented, the state of data-holding subsystem 204 may be transformed (for example, to hold different data).

As described above, the server 102 may be a web server for automatically generating hyperlinks in a document such as a webpage. In particular, as described further herein, the hyperlink generation engine 104 may evaluate code relating to electronic files metadata uploaded to the data-holding subsystem 204, generate one or more databases 206, including the webpage database index 114 and the webpage database 116 of FIG. 1, based on the evaluated code, and automatically generate a hyperlink without further user input. Although the one or more databases 206 are depicted as stored in the data-holding subsystem 204 of the server 102, it should be appreciated that in some examples, the one or more databases 206 may be stored in a separate computing system communicatively coupled to the server 102 and accessible via the network 110.

The server 102 may further include a display subsystem 208 and a communication subsystem 210. When included, display subsystem 208 may be used to present a visual representation of data held by data-holding subsystem 204. As the herein described methods and processes change the data held by the data-holding subsystem 204, and thus transform the state of the data-holding subsystem 204, the state of display subsystem 208 may likewise be transformed to visually represent changes in the underlying data. Display subsystem 208 may include one or more display devices utilizing virtually any type of technology. Such display devices may be combined with logic subsystem 202 and/or data-holding subsystem 204 in a shared enclosure, or such display devices may be peripheral display devices.

When included, communication subsystem 210 may be configured to communicatively couple the server 102 with one or more other computing devices, such as client system 108. Communication subsystem 210 may include wired and/or wireless communication devices compatible with one or more different communication protocols. As non-limiting examples, communication subsystem 210 may be configured for communication via a wireless telephone network, a wireless local area network, a wired local area network, a wireless wide area network, a wired wide area network, etc. In some embodiments, communication subsystem 210 may allow the server 102 to send and/or receive messages to and/or from other devices via the public Internet. For example, communication subsystem 210 may communicatively couple the server 102 with client system 108 via the network 110. In some examples, the network 110 may be the public Internet. In other examples, the network 110 may be regarded as a private network connection and may include, for example, a virtual private network or an encryption or other security mechanism employed over the public Internet.

Further, the server 102 provides a network service that is accessible to a plurality of users through a plurality of client systems such as the client system 108 communicatively coupled to the server 102 via the network 110. As such, the networked computing system 200 may include one or more devices operated by users, such as client system 108. Client system 108 may be any computing device configured to access a network such as network 110, including but not limited to a personal desktop computer, a laptop, a smartphone, a tablet, and the like. While one client system 108 is shown, it should be appreciated that any number of user devices or client systems may be communicatively coupled to the server 102 via the network 110.

Client system 108 includes a logic subsystem 212 and a data-holding subsystem 214. Client system 108 may optionally include a display subsystem 216, communication subsystem 218, a user interface subsystem 220, and/or other components not shown in FIG. 2.

Logic subsystem 212 may include one or more physical devices configured to execute one or more instructions. For example, logic subsystem 212 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 212 may include one or more processors that are configured to execute software instructions. Additionally or alternatively, the logic subsystem 212 may include one or more hardware or firmware logic machines configured to execute hardware or firmware instructions. Processors of the logic subsystem 212 may be single or multi-core, and the programs executed thereon may be configured for parallel or distributed processing. The logic subsystem 212 may optionally include individual components that are distributed throughout two or more devices, which may be remotely located and/or configured for coordinated processing. One or more aspects of the logic subsystem 212 may be virtualized and executed by remotely accessible networking computing devices configured in a cloud computing configuration.

Data-holding subsystem 214 may include one or more physical, non-transitory devices configured to hold data and/or instructions executable by the logic subsystem 212 to implement the herein described methods and processes. When such methods and processes are implemented, the state of data-holding subsystem 214 may be transformed (for example, to hold different data).

Data-holding subsystem 214 may include removable media and/or built-in devices. Data-holding subsystem 214 may include optical memory (for example, CD, DVD, HD-DVD, Blu-Ray Disc, etc.), and/or magnetic memory devices (for example, hard drive disk, floppy disk drive, tape drive, MRAM, etc.), and the like. Data-holding subsystem 214 may include devices with one or more of the following characteristics: volatile, nonvolatile, dynamic, static, read/write, read-only, random access, sequential access, location addressable, file addressable, and content addressable. In some embodiments, logic subsystem 212 and data-holding subsystem 214 may be integrated into one or more common devices, such as an application-specific integrated circuit or a system on a chip.

When included, display subsystem 216 may be used to present a visual representation of data held by data-holding subsystem 214. As the herein described methods and processes change the data held by the data-holding subsystem 214 and thus transform the state of the data-holding subsystem 214, the state of display subsystem 216 may likewise be transformed to visually represent changes in the underlying data. Display subsystem 216 may include one or more display devices utilizing virtually any type of technology. Such display devices may be combined with logic subsystem 212 and/or data-holding subsystem 214 in a shared enclosure, or such display devices may be peripheral display devices.

In one example, the client system 108 may include executable instructions 222 in the data-holding subsystem 214 that, when executed by the logic subsystem 212, cause the logic subsystem 212 to perform various actions as described further herein. As one example, the client system 108 may be configured, via the instructions 222, to receive a webpage including one or more hyperlinks transmitted by the server 102, and display the hyperlinked webpage via a graphical user interface on the display subsystem 216 to a user.

When included, communication subsystem 218 may be configured to communicatively couple client system 108 with one or more other computing devices, such as the server 102. Communication subsystem 218 may include wired and/or wireless communication devices compatible with one or more different communication protocols. As non-limiting examples, communication subsystem 218 may be configured for communication via a wireless telephone network, a wireless local area network, a wired local area network, a wireless wide area network, a wired wide area network, etc. In some embodiments, communication subsystem 218 may allow the client system 108 to send and/or receive messages to and/or from other devices, such as the server 102, via the network 110.

The client system 108 may further include the user interface subsystem 220 including user input devices such as keyboards, mice, game controllers, cameras, microphones, and/or touch screens. A user of client system 108 may input a request to load or otherwise interact with the hyperlink of the webpage stored by the server 102, for example, via user interface subsystem 220.

Thus the server 102 and the client system 108 each represent computing devices which may generally include any device that is configured to perform computation and that is capable of sending and receiving data communications by way of one or more wired and/or wireless communication interfaces. Such devices may be configured to communicate using any of a variety of network protocols. For example, the client system 108 may be configured to execute a browser application stored as the instructions 222 that employs HTTP to request information from the server 102 and then displays the retrieved information to a user on a display such as the display subsystem 216.

The hyperlink generation engine, e.g., the hyperlink generation engine 104 of FIGS. 1 and 2, may allow hyperlinks of a webpage to be automatically inserted. In contrast to conventional methods for automatically inserting hyperlinks into the webpage, which may include inserting the hyperlinks at predetermined keywords, the hyperlink generation engine 104 may add, hide, and/or remove hyperlinks based on user engagement with the webpage. By adding hyperlinks according to an indicated interest of the user, with respect to specific terms, phrases, or other structural elements displayed within a visible screen of the webpage, a user experience may be enhanced when navigating the webpage and the user may obtain desired information more efficiently. A presentation of the hyperlinks may be tailored to the user's preferences and, as hyperlink generation and placement is continually modified, a likelihood of outdated and/or broken links may be reduced. Furthermore, the hyperlinks may be positioned in more aesthetically appealing and meaningful locations in the webpage, thereby increasing a likelihood that the user interacts with the hyperlinks.

In one example, the appearance/disappearance of the hyperlinks may occur based on a predetermined time threshold, e.g., the hyperlinks may be time-lapsed or time-released. The time-lapsed appearance/ hiding of the hyperlinks may be executed according to a set of rules implemented at the hyperlink generation engine. For example, the user may set a time interval on a global basis for a website, a type of hyperlink, or according to a user experience from interacting with the webpage. The time interval may be set based on the hyperlinks, the website (e.g., all hyperlinks from a specific website), or types of hyperlinks, such as affiliate links, external links, internal links, etc. As another example, the hyperlinks may be added based on an idle behavior of the user. For example, when a portion of the webpage remains on a visible screen for the time threshold without changes to the visible screen, insertion of hyperlinks may be prompted.

When the user engages with an element of the webpage, such as a term, phrase, image, icon, etc., for at least the time threshold, the hyperlink generation engine may command a change in the webpage at the engaged element. The time threshold may be a period of time that is longer than an expected period of time for the cursor to remain stationary over an element when the user is scrolling through the webpage, such as 5 seconds, 10 seconds, etc. Alternatively, in instances where the cursor is not present, e.g., at a screen of a mobile phone, the time threshold may be a period of time that is longer than the expected period for the user to scroll to another portion of the webpage. In some examples, changes at other regions of the webpage, other than at the engaged element, may be initiated concurrently, in response to the engagement. Engagement of the user with the element may be indicated by, as one example, the user positioning a mouse cursor over or in close proximity to the element. In other examples, user engagement may include the user placing a finger over the element at a screen, e.g., a touchscreen. Various other indications of user interaction and interest are possible.

The change in the webpage at the engaged element may include an appearance of a hyperlink, for example. When the engaged element is a term or a phrase of the webpage text, the term or the phrase may be converted to an anchor of the hyperlink. For example, as shown in FIG. 3A, a visible screen 300 of a webpage, e.g., a portion of the webpage visible to a user, may include a paragraph of text 302. The paragraph of text 302 may include a first hyperlink 304, anchored at “axe throwing”, and a second hyperlink 306, anchored at “darts”. A cursor 308 is positioned to point to “lumberjack” in the paragraph of text 302.

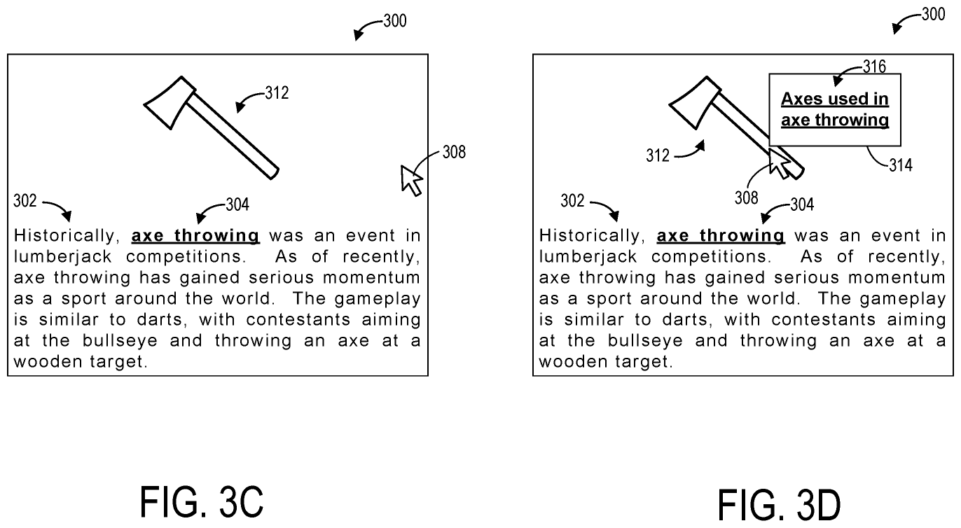

When the cursor is positioned as shown in FIG. 3A for at least a first threshold period of time, the hyperlink generation engine may deem “lumberjack” to be a term of interest. The term “lumberjack” may be converted to an anchor of a hyperlink, as shown in FIG. 3B by generation of a third hyperlink 310, thereby linking the term to another webpage or website with additional information regarding lumberjacks. The first threshold period of time may be, for example, 10 seconds. In some examples, as in FIG. 4 and described further below, a timer may be initiated to monitor a duration of time that the cursor remains positioned as shown in FIG. 3A. The timer may operate invisibly in a background of the webpage or may be presented by a visual user interface design as, for example, a timer clock.

The appearance of the third hyperlink 310 may be presented to the user by the hyperlink generation engine as defined by the set of rules. For example, the third hyperlink 310 may gradually change from an appearance of regular text, e.g., text surrounding the third hyperlink 310, to a different color, typeface, boldface, or other attribute associated with hyperlinks. In one example, the third hyperlink 310 may fade in. In another example, the third hyperlink 310 may appear with a more pronounced effect, such as flashing, bouncing, changing colors and/or size, until the user interacts with the third hyperlink 310.

Furthermore, in some instances, the set of rules may include instructions to remove or hide the third hyperlink 310 if the user does not engage with the third hyperlink 310 within a second threshold period of time. The second threshold period of time may be similar to or longer than the first threshold period of time. In some examples, the second threshold period of time may be set by the user based on time-trigger events. The time thresholds, e.g., the first and the second threshold periods of time, may be adapted to promote user navigation through the webpage and interaction with time-sensitive hyperlinks. If the user does not click on the third hyperlink 310 using the cursor 308, or otherwise engage with the third hyperlink 310, the third hyperlink 310 may disappear, returning the term “lumberjack” to regular text, as shown in FIG. 3A. Hiding of the third hyperlink 310 may include the appearance attributes associated with hyperlinks fading or abruptly returning to the appearance of the regular text, for example.

Hiding a hyperlink may include modifying the hyperlink to be a disappearing hyperlink. For example, style attributes of the hyperlink may be altered such that the hyperlink presentation includes temporarily hiding the hyperlink. Neither hiding the hyperlink or, in examples where the hyperlink is removed, may affect SEO or searching. In one example, this may be achieved as described above by configuring the hyperlink to disappear but code associated with the hyperlink remains and/or by adding meta data that customizes an add/removal process for the hyperlink.

For example, if the user does not engage with an already existing hyperlink in the webpage and additionally navigates away from the already existing hyperlink, the hyperlink may be hidden or removed. For example, as shown in FIG. 3C, the user may scroll upwards in the webpage such that an image 312 positioned above the paragraph of text 302 is visible at the visible screen 300. As the cursor 308 is positioned further away from the second hyperlink 306, as shown in FIGS. 3A and 3B, the second hyperlink 306 may be hidden when the cursor 308 remains positioned distal to an anchor of the second hyperlink 306, e.g., the term “darts” for at least a third threshold period of time. In other words, an appearance of paragraph of text 302 may revert from that of FIG. 3C to that of FIG. 3A. Newly created hyperlinks, such as the third hyperlink 310 of FIG. 3B, may be similarly hidden, if not engaged with, within, the third threshold period of time. The third threshold period of time may be similar to or longer than the first and second threshold periods of time.

In some examples, a hyperlink that disappears after the third threshold period of time without user engagement may still be encoded or embedded into the text. For example, the second hyperlink 306 of FIG. 3A, although not visible in FIG. 3C, may still be present in the paragraph of text 302. The set of rules input to the hyperlink generation engine may include instructions to maintain the presence of the hidden second hyperlink 306 and initiate reappearance of the hyperlink when user interaction with the paragraph of text 302 indicates an interest in “darts”, e.g., by detecting hovering of the cursor 308 over “darts”. Alternatively, the user may scroll away from the paragraph of text 302 and interact with another webpage element suggestive of an interest in darts, which may initiate reappearance of the second hyperlink 306 if the user returns to view the paragraph of text 302.

A hyperlink may be removed, e.g., code associated with the hyperlink adjusted to plain text, either in place of hiding of the hyperlink or in addition to hiding the hyperlink. In one example, the hyperlink may first be hidden after the third threshold period of time passes without user engagement. The hidden hyperlink may eventually be removed after a fourth threshold period of time lapses subsequent to initial hiding of the hyperlink. The fourth threshold period of time may be an additional duration of time that the user does not engage with any elements related to the hyperlink, including the original element that the hyperlink was presented at, or any other elements corresponding to a similar or related topic.

Hiding/removal of the already existing hyperlink based on user navigation away from the hyperlink for the third threshold period of time may be defined by the set of rules input to the hyperlink generation engine. For example, a timer may be initiated when the cursor 308 of FIGS. 3A-3D moves away from a hyperlink by a threshold distance, where the threshold distance may be a percentage of a length or width of the visible screen 300, a number of characters separating the hyperlink from the cursor 308, a physical distance such as 10 cm, a quantity of pixels or characters, a percentage, etc. If the cursor 308 remains beyond the threshold distance from the hyperlink for at least the third threshold period of time, the hyperlink may be deemed of little interest to the user and removed as a result.

In addition, a hidden hyperlink may be removed when a number of hyperlinks of a visible screen of a webpage reaches a threshold number, e.g., a maximum number of hyperlinks which may be included in the set of rules. The maximum number of hyperlinks may be a quantity of visible hyperlinks above which an appearance of the visible screen may become cluttered and unappealing. When hyperlinks are added to the webpage based on user behavior, hidden hyperlinks may be removed to balance hyperlink addition.

Automated hyperlink generation based on user engagement may also include presenting a new hyperlink as a pop-up when the cursor is positioned over content in the webpage that is not displayed as text. For example, as shown in FIG. 3D, the cursor 308 may be positioned over the image 312 for a fifth threshold period of time which may be similar to the first threshold period of time.

When the fifth threshold period of time lapses with the cursor 308 positioned over the image 312, the set of rules may include instructions to identify the image 312 to be a candidate hyperlink anchor and generate a pop-up 314 to display a new, fourth hyperlink 316. Additionally or alternatively, a Cascading Style Sheet (CSS) may be used to set a style of the fourth hyperlink 316. For example, the style may be set to add a border, underlining, highlighting to the anchor text of the fourth hyperlink 316, as well as a timer, a widget, or various other types of styling. The fourth hyperlink 316 may be presented as a phrase that is relevant to the image 312. For example, as shown in FIG. 3D, the image 312 is an axe and the anchor of the fourth hyperlink 316 is the phrase “Axes used in axe throwing”. The fourth hyperlink 316 may be linked to a destination, such as another webpage or website, providing information regarding types of axes used in axe throwing.

The fourth hyperlink 316 may be displayed for a sixth threshold period of time. In one example, the sixth threshold period of time may be as long as the cursor 308 remains positioned over the image 312. In another example, the sixth threshold period of time may be a duration of time elapsed subsequent to initial display of the fourth hyperlink 316, during which the user does not proceed to interact with the fourth hyperlink 316. The hyperlink generation engine may be configured to remove or hide the pop-up 314 if the user does not engage with the fourth hyperlink 316 for the sixth threshold period of time. The sixth threshold period of time may be 10 seconds, for example, and may be set to create time-driven events associated with the hyperlinks to guide navigation and interaction of the user.

Furthermore, in some examples, an option to reinsert or redisplay the pop-up 314 (any hyperlink removed or hidden after the sixth threshold period of time elapses) may be provided to the user. For example, a hyperlink stating “reveal again” may replace the fourth hyperlink 316, thereby allowing the user to reinstate the fourth hyperlink 316 by selecting the “reveal again” hyperlink. As such, the user is given another opportunity to interact with the fourth hyperlink 316 if the user was previously unable to do so within a time frame of the sixth threshold period of time.

In yet another example, the pop-up 314 may be removed from the visible screen 300 if the user navigates away from the image 312 before the sixth threshold period of time elapses. For example, if the cursor 308 is moved away from the image 312 by the threshold distance described above, the fourth hyperlink 316 may be deemed of little interest to the user and removed as a result.

Removal/hiding of a hyperlink or a pop-up may include configuring the hyperlink/pop-up to disappear according to the set of rules. For example, the set of rules may include instructions for the hyperlink or pop-up to gradually fade away. In another example, the hyperlink or pop-up may disappear rapidly. It will be appreciated that the hyperlink/pop-up may be configured to appear and disappear according in various ways without departing from a scope of the present disclosure.

As described above, a timer may be initiated upon insertion of a new hyperlink. The timer may be invisible or displayed at a visible screen, as shown in FIG. 4. Therein, a visual depiction of a timer 400 is provided in an upper right hand corner of the visible screen 300. The timer 400 is presented as a timer clock visually indicating a countdown from a threshold period of time. In one example, the threshold period of time, as described above, may be a period of time elapsed during which a user does not interact with a hyperlink. A countdown may be initiated, for example, upon the user scrolling or navigating to and stopping at the visible screen 300, and not scrolling beyond, e.g., outside of, the visible screen 300. For example, the user may not engage with the first hyperlink 304 shown in the visible screen 300. The threshold period of time may be 5 seconds, as shown in FIG. 4, and a hand of the timer clock may move according to the countdown from 5 seconds to 0 seconds. It will be appreciated, however, that the depiction of the timer 400 of FIG. 4 is a non-limiting example and the timer 400 may be presented in a variety of clocks, timing devices, or simply as numbers changing as time elapses.

In some examples, the threshold period of time may be set by the user. When the countdown is complete, the first hyperlink 304 may disappear, as well as the visual depiction of the timer 400. In other examples, such as for coupon links or dynamic, changing hyperlinks, the timer 400 may inform the user of when the coupon link is to expire or when the dynamic hyperlinks transition to different hyperlinks. In yet other examples, a styling of a hyperlink or a destination of the hyperlink may change when the countdown is complete or a link, e.g., a “reveal again” link, may appear when the hyperlink is removed upon countdown termination. If the user engages with the “reveal again” link, the removed hyperlink may be reinserted.

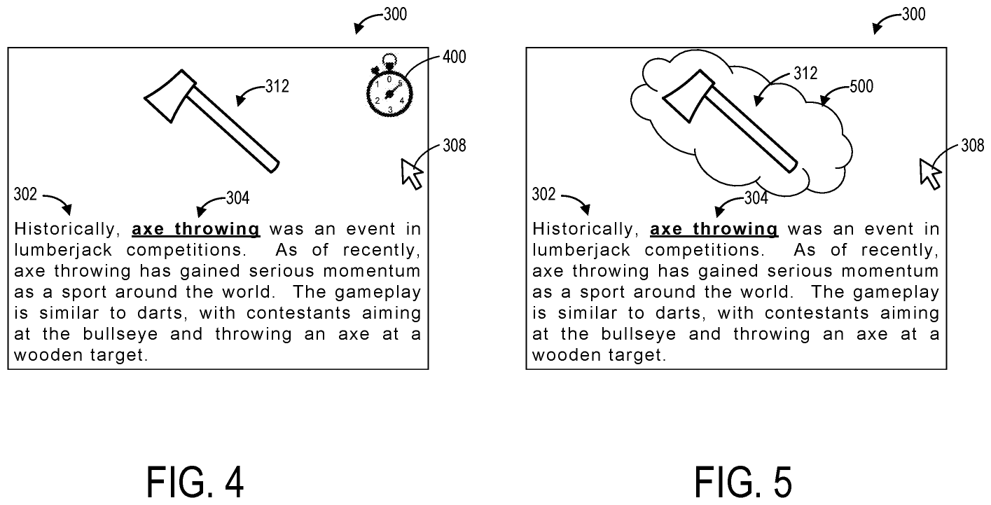

The countdown based on the timer, as described above with reference to FIG. 4, may also be used to modify a hyperlinked image. For example, the image 312 of FIGS. 3A-4 is depicted in FIG. 5 highlighted by a cloud 500. Upon completion of the countdown without user interaction with the first hyperlink 304, the image 312 may be modified as shown in FIG. 5, or by adding a border, varying a background of the image 312, etc., to draw attention to the hyperlinked image 312. The modification may be similarly timed to be maintained for a preset duration of time, after which the modification to the image 312 may disappear. In some examples, sections, or at least a portion, of the image 312 may each be configured as different hyperlinks and the hyperlinks may be added and/or removed over time periods specific to each of the sections.

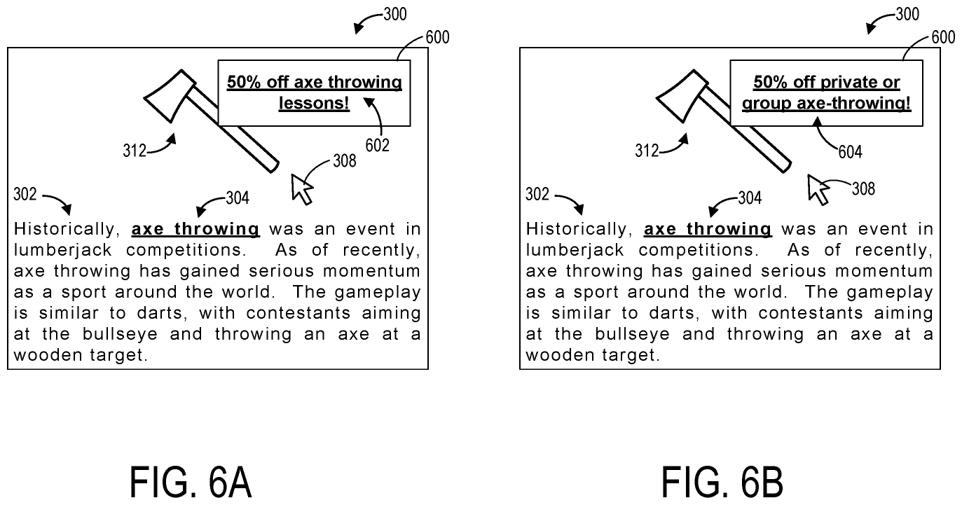

As illustrated in FIGS. 6A-6B, time-driven modification of a hyperlink may also be configured to rotate the hyperlink through a series of related hyperlinks. For example, the image 312 may be an anchor for a product hyperlink. As shown in FIG. 6A, a pop-up 600 may appear when the cursor 308 approaches the image 312, e.g., comes within a threshold distance of the image 312. Alternatively, in displays without a cursor, such as a screen of a mobile phone, the pop-up 600 may appear after the image 312 is visible for a first threshold duration of time, as monitored by a timer, such as the timer 400 of FIG. 4. The pop-up 600 may initially present a first product hyperlink 602, which, as an example, may advertise discounted axe-throwing lessons and may enable navigation to a destination URL for an axe-throwing school or classes.

As shown in FIG. 6B, if the user does not engage with the first product hyperlink 602, the hyperlink generation engine may be configured to replace the first product hyperlink 602 with a second product hyperlink 604 after a second threshold duration of time passes. The second product hyperlink 604 may be related to the first product hyperlink 602 but may be linked to a different destination URL, e.g., to a website for an axe-throwing facility advertising rental of the facility. The hyperlink generation engine may be configured with a set of hyperlinks and corresponding destinations relevant to the image 312 and may cycle through the set of hyperlinks according to the second threshold duration of time continuously as long as the user does not engage with the pop-up 600. In other examples, the set of hyperlinks may be similarly coupled to text instead of an image.

Various other adaptations for dynamic, time-driven insertion and removal of hyperlinks are possible. For example, hyperlinks may be added to videos embedded in a webpage. The hyperlinks may correspond to topics discussed or shown in the video and may be synchronized to appear when a relevant topic is addressed in the video. In one example, a timing of the hyperlinks may be determined based on a transcript of the video.

As another example of time-driven modification of hyperlinks, a hyperlink may be removed from the webpage based on user input by configuring the hyperlink with a pop-up displaying a link with text such as “not interested”. The pop-up may appear after a threshold period of time elapses without user engagement with the link. If the user clicks on the “not interested” link, the hyperlink may be hidden or removed, as well as the pop-up.

Time-driven hyperlinks may also be hidden/removed, or added, in response to user navigation of the webpage. For example, the user may pause at a section of the webpage and then scroll down, away from the section of the webpage. The user may subsequently scroll back up to return to the section, indicating the user's interest in the section. A timer may be reset when the user returns to the section, triggering a change in a styling of one or more hyperlinks in the section, where the timer allows monitoring of time elapsed before hiding/removal or another change to the styling of the one or more hyperlinks is performed.

Additionally, the webpage may be configured with a time-driven “Easter egg” hyperlink. The “Easter egg” hyperlink (hereafter, Easter egg) may be revealed after the user performs a predetermined set of actions at the webpage, where the Easter egg may remain hidden in the webpage until the set of actions are executed. The set of actions may be defined at settings of the hyperlink generation engine, e.g., based on the set of rules. For example, the set of actions may include watching a video after which a related hyperlink appears and instructions for performing the set actions may be displayed to the user as a pop-up, as one example. The Easter egg may increase an entertainment value and intrigue of the webpage and motivate continued engagement from the user.

An example of a method 700 for automatically generating hyperlinks based on user engagement with an electronic document, such as a webpage, is shown in FIG. 7 and an example of a method 800 for automatically removing hyperlinks, also based on user engagement (or lack thereof), is shown in FIG. 8. Instructions for carrying out methods 700 and 800 may be executed by a hyperlink generation engine, such as the hyperlink generation engine 104 of FIGS. 1 and 2, based on a set of rules input to the hyperlink generation engine, implemented at a processor of a server and/or a client system, such as the server 102 and the client system 108 of FIGS. 1 and 2. In one example, the set of rules may be user-defined rules incorporated into code of the webpage.

Turning first to method 700 of FIG. 7, at 702, the method includes determining if a distance between a candidate anchor, e.g., a webpage element identified to be potentially relevant to topics described by the webpage, and a cursor, e.g., a mouse cursor, to be less than a first threshold. The candidate anchor may be a keyword, an image, an icon, or some other type of structural element of the webpage that is not currently hyperlinked but may be used as a hyperlink anchor according to the set of rules. For example, the set of rules may include a list of keywords and types of structural elements which may be implemented as hyperlink anchors, as well as instruction regarding how the hyperlinks are to be presented, displayed, formatted, etc.

The first threshold may be a distance between the candidate anchor and the cursor that may be indicative of user interest. As one example, the first threshold may include direct placement of the cursor over the candidate anchor. As another example, the first threshold may be a radius of 5 characters, relative to the candidate anchor, when the candidate anchor is a term or phrase in a paragraph of text. As another example, the first threshold may be a percentage of a height or width of a visible portion of the webpage, e.g., a visible screen such as the visible screen 300 of FIGS. 3A-3D, such as 5%.

In yet another example, particularly in instances where the cursor is not present or where a screen size is small, such as at a screen of a mobile phone or tablet, user interest may be indicated by scrolling a region of the webpage into view, the region including one or more hyperlinks. For example, if the screen height and width are below threshold dimensions, hyperlink insertion may be triggered based on scrolling and pausing as executed by the user. More specifically, when the user pauses, demonstrating idle behavior, for at least a threshold period of time, interest in the visible portion of the webpage may be indicated.

If the distance between the candidate anchor and the cursor is not less than the first threshold, the method continues to 704 to maintain a current set of hyperlinks present in the visible screen of the webpage and returns to the start. If the distance is equal to or less than the first threshold, the method proceeds to 706 to initiate a timer. The timer may be invisible or may be displayed at the visible screen, e.g., as shown in FIG. 4. At 708, the method includes confirming if an amount of time elapsed since initiation of the timer reaches a second threshold. The second threshold may be an amount of time defined by the set of rules deemed indicative of the user's interest in the candidate anchor, such as 10 seconds.

If the elapsed time does not reach the second threshold, the method returns to 708 to continue monitoring the time. It will be noted that if the user navigates, e.g., moves the cursor, away from the candidate anchor beyond the first threshold before the second threshold elapses, the method returns to the start. If the elapsed time reaches the second threshold, the method continues to 710 to confirm if the candidate anchor is formed of text, e.g., a term or phrase. If the candidate anchor is not formed of text, the method proceeds to 714 to identify a topic relevant to the candidate anchor. For example, the candidate anchor may be an image, such as the image 312 of FIGS. 3C-6B. The hyperlink generation engine may be configured to identify the image, e.g., by assigning a keyword corresponding to alt text of the image, for example, and search a list or database of destinations based on the keyword. If the keywords correspond to more than one destinations, a relevancy of the destinations may be ranked. A destination with highest relevancy may be linked to the image and presented as a hyperlink in a pop-up, such as the pop-up 314 of FIG. 3D, at 716. The pop-up may be displayed proximate to the image and/or the cursor and may appear gradually, suddenly, with or without motion, or with or without some other attribute that increases a visibility of the pop-up.

In another example, a hyperlink may be added to elements around the image or to portions of the image. When the user interacts with the elements around the image or with a specific portion of the image a modification may be made to the image. For example, a highlighted border may appear around the image or a timer clock may appear. As such, the hyperlink may not be associated text and instead may be implemented at a section of the webpage.

Returning to 710, if the candidate anchor is formed of text, the method includes generating and displaying a new hyperlink at the candidate anchor at 712. For example, the term or phrase assigned to be the candidate anchor may be modified to have a different font, color, boldness, underlining, etc. The modification may appear gradually or suddenly, with or without some other attribute that increases a visibility of the new hyperlink, such as flashing, motion, changing color, etc. Method 700 then returns to the start.

While method 700 is described above for generation of one new hyperlink or pop-up, method 700 may be executed for generation of more than one new hyperlink or pop-up concurrently. For example, as described at 702, more than one candidate anchor may be positioned from the cursor at a distance less than the first threshold. Thus, method 700 may be applied to each candidate anchor at the same time. Similarly, when the cursor is not present, such as when the webpage is displayed at a mobile phone or tablet, when the user scrolls to a section of the webpage with more than one candidate anchor present in the visible screen, more than one hyperlink may be inserted.

However, the set of rules may include a maximum number of new hyperlinks to be generated concurrently, such as two or three, to circumvent formation of a number of new hyperlinks that leads to a cluttered appearance of hyperlinks in the visible screen. Furthermore, the website may be configured with time-driven goals for the user based on the webpage of the website and/or type of content. A distance between the hyperlinks may be determined to optimize placement and promote continued navigation and interaction by the user.

Turning now to FIG. 8, method 800 includes determining if a distance between the cursor and an anchor of an already existing hyperlink is greater than a third threshold. The anchor of the already existing hyperlink may be, for example, a term or phrase in a paragraph of text. As another example, the anchor may instead be an image, an icon, or some other structural element of the webpage and the hyperlink may be displayed in a pop-up. The third threshold may be a distance between the cursor and the anchor that is greater than the first threshold of method 700 and deemed, according to the set of rules, to indicate a lack of interest of the user. For example, the third threshold may be a radius of 20 characters when the anchor is the term or phrase in the paragraph of text. As another example, the third threshold may be a percentage of the height or width of the visible screen of the webpage, such as 40% or 60%.

If the distance between the anchor and the cursor is not greater than the third threshold, method 800 proceeds to 804 to maintain the current hyperlinks presented at the visible screen of the webpage. Method 800 returns to the start. If the distance is greater than the third threshold, method 800 includes initiating the timer at 806.

At 808, method 800 includes confirming if the elapsed time reaches a fourth threshold. The fourth threshold may be a period of time at which the cursor remains distanced from the anchor, e.g., the distance greater than the third threshold, sufficiently long to indicate the user does not intend to engage with the anchor. For example, the fourth threshold may be 20 seconds. The fourth threshold may or may not be longer than the second threshold of method 700. If the elapsed time does not reach the fourth threshold, the method returns to 808 to continue monitoring the timer. It will be appreciated that if the user navigates, e.g., moves the cursor, to the anchor within the first threshold of FIG. 7 before the elapsed time reaches the fourth threshold, method 800 returns to the start.

If the elapsed time reaches the fourth threshold, method 800 continues to 810 to hide or remove the hyperlink. Hiding the hyperlink may include, for example, modifying and appearance of the hyperlink such that the hyperlink is not visible, e.g., the anchor is displayed without any visual attribute associated with other hyperlinks. However, the hyperlink, e.g., code assigned the anchor to a corresponding destination remains embedded in the electronic document. Alternatively, the hyperlink may be removed, which may include, for example, decoupling the anchor of the hyperlink from the destination. For either case, when the anchor is formed of text, the text that is or was formerly the anchor may be adjusted to an appearance similar to the surrounding text. For example, a font, boldness, underlining, color, etc., of the text may be changed to the corresponding attributes of the surrounding text. When the hyperlink is displayed in the pop-up, the pop-up may disappear. The hiding or removal of the hyperlink may be gradual, e.g., the hyperlink fades away, or may be abrupt.

In some examples, as described above, the set of rules may include instructions to hide the hyperlink after the fourth threshold elapses, and then remove the hyperlink after another period of time, subsequent to the fourth threshold, passes. As such, lack of user engagement results first in disappearance of the hyperlink, followed by removal after prolonged disinterest is indicated. Alternatively, the hyperlink may be removed after the fourth threshold elapses, rather than first hiding the hyperlink, when a quantity of hyperlinks displayed in visible screen of the webpage reaches a maximum number.

Furthermore, as described above, method 800 may be implemented concurrently to hide or remove more than one hyperlink. For example, if distances between more than one already existing hyperlink and the cursor each exceed the third threshold of 802, method 800 may be executed for each of the more than one already existing hyperlinks. In instances where the cursor is not present, e.g., at mobile phone or tablet screens, all hyperlinks displayed at the visible screen may be hidden, removed, or a combination of hiding and removal. Additionally, method 800 may be performed in conjunction with or concurrently with method 700. As such, generation of new hyperlinks and removal of hyperlinks may occur simultaneously.

In this way, a presentation of hyperlinks at a visible screen of a webpage may be automatically and dynamically updated. By predicting topics of interest to a user based on user engagement with the webpage, relevant and useful information may be provided to the user in a customized manner. In addition, hyperlinks that are not useful to the user, determined based on a lack of interaction of the user with the hyperlinks, may be hidden and/or removed from the visible screen. As such, only hyperlinks with high likelihood of supplying information of interest to the user may be presented at the visible screen, allowing the user to locate the information of interest more efficiently. Furthermore, the dynamic updating of the hyperlinks reduces incorporation of broken or dead hyperlinks which may lead to greater user satisfaction when navigating the webpage.

The technical effect of automatically inserting and removing hyperlinks based on a duration of time of user interaction is that a relevance of the hyperlinks relative to user interest is increased, thereby providing more efficient access to information while maintaining an organized appearance of the webpage with reduced broken or obsolete hyperlinks.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the systems described above with respect to FIG. 1. The methods may be performed by executing stored instructions with one or more logic devices (e.g., processors) in combination with one or more hardware elements, such as storage devices, memory (including non-transitory memory), hardware network interfaces/antennas, switches, actuators, clock circuits, and so on. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

The disclosure also provides support for a method for automatically inserting hyperlinks, comprising: monitoring a user's interaction with a document via algorithms of a hyperlink generation engine implemented at a processor of a client system, identifying a structural element in the document of interest to the user, based on the user's interaction and a set of rules input to the hyperlink generation engine, automatically modifying the structural element to include a first hyperlink, and automatically displaying the modified structural element in the document at a display device. In a first example of the method, the method further comprises: hiding or removing a second hyperlink from the document when the user does not interact with the second hyperlink for a second threshold period of time. In a second example of the method, optionally including the first example, the structural element is one of a term, a phrase, an icon, or an image. In a third example of the method, optionally including one or both of the first and second examples, automatically modifying the structural element to include the first hyperlink includes converting the structural element to an anchor of the first hyperlink, and wherein converting the structural element includes modifying an appearance of the structural element. In a fourth example of the method, optionally including one or more or each of the first through third examples, the structural element is identified to be of interest to the user based on a positioning of a cursor over of the structural element. In a fifth example of the method, optionally including one or more or each of the first through fourth examples, automatically modifying the structural element to include the first hyperlink includes modifying the structural element when the user stops navigating the document and maintains the structural element within a visible screen of the display device for a predetermined period of time. In a sixth example of the method, optionally including one or more or each of the first through fifth examples, the method further comprises: displaying an Easter egg in response to the user performing a predetermined set of actions, and wherein instructions for the predetermined set of actions are displayed at the display device.

The disclosure also provides support for a method for modifying a presentation of hyperlinks in a document, comprising: automatically inserting, using a processor, a first hyperlink into a first region of the document based on a first period of time of user engagement with the first region, the first region of the document displayed at a display device, and automatically modifying a second hyperlink to disappear, using the processor, from a second region of the document based on a second period of time without user engagement, the second region separate and distanced from the first region by a threshold distance and also displayed at the display device. In a first example of the method, automatically inserting the first hyperlink includes configuring an appearance of the first hyperlink to be gradually modified, and wherein a gradual modification of the appearance of the first hyperlink includes one or more of changing a typeface, a color, a boldness, an underlining, and adding motion at the first hyperlink. In a second example of the method, optionally including the first example, automatically inserting the first hyperlink includes displaying a pop-up with the first hyperlink presented in the pop-up. In a third example of the method, optionally including one or both of the first and second examples, automatically modifying the second hyperlink to disappear includes one or more of hiding the second hyperlink and removing the second hyperlink, and further includes configuring the second hyperlink to appear to fade away. In a fourth example of the method, optionally including one or more or each of the first through third examples, the threshold distance is determined based on one of a number of characters between the first region and the second region and a percentage of each of a height and a width of a screen of the display device. In a fifth example of the method, optionally including one or more or each of the first through fourth examples, each of automatically inserting the first hyperlink and automatically modifying the second hyperlink to disappear is executed based on a set of rules defined by a user.

The disclosure also provides support for a system for automatically modifying hyperlinks, comprising: a document displayed at a display device, and a processor, communicatively coupled to the display device and configured with executable instructions stored in non-transitory memory that, when executed, cause the processor to: monitor a user's interaction with the document, automatically insert a first hyperlink into a first region of the document based on a first period of time of user engagement with the first region, automatically remove a second hyperlink from a second region of the document based on a second period of time without user engagement, the second region separate and distanced from the first region by a threshold distance, and display the document at the display device with the first hyperlink visible and without the second hyperlink visible. In a first example of the system, the first hyperlink is automatically inserted and the second hyperlink is automatically removed based on a hyperlink generation engine configured with algorithms defining how hyperlinks are added and removed. In a second example of the system, optionally including the first example, the second hyperlink is automatically removed when a period of time elapses without user interaction with the second hyperlink, and wherein the period of time is monitored via a timer. In a third example of the system, optionally including one or both of the first and second examples, the timer is one of invisible or displayed at a visible portion of the document at the display device. In a fourth example of the system, optionally including one or more or each of the first through third examples, the first hyperlink is displayed by rotating the first hyperlink through a series of related anchors and corresponding destinations according to a predetermined passage of time. In a fifth example of the system, optionally including one or more or each of the first through fourth examples, the first hyperlink is automatically inserted by adding the first hyperlink to an element around an image of the document or to at least one portion of the image, and wherein an appearance of the first hyperlink changes according to a predetermined time interval. In a sixth example of the system, optionally including one or more or each of the first through fifth examples, the second hyperlink is hidden prior to being removed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” “third,” and so on are used merely as labels, and are not intended to impose numerical requirements or a particular positional order on their objects. The following claims particularly point out subject matter from the above disclosure that is regarded as novel and non-obvious.

1. A method for automatically inserting hyperlinks, comprising:
monitoring a user's interaction with a document via algorithms of a hyperlink generation engine implemented at a processor of a client system;
identifying a structural element in the document of interest to the user, based on the user's interaction and a set of rules input to the hyperlink generation engine;
automatically modifying the structural element to include a first hyperlink; and
automatically displaying the modified structural element in the document at a display device.

2. The method of claim 1, further comprising hiding or removing a second hyperlink from the document when the user does not interact with the second hyperlink for a second threshold period of time.

3. The method of claim 1, wherein the structural element is one of a term, a phrase, an icon, or an image.

4. The method of claim 1, wherein automatically modifying the structural element to include the first hyperlink includes converting the structural element to an anchor of the first hyperlink, and wherein converting the structural element includes modifying an appearance of the structural element.

5. The method of claim 1, wherein the structural element is identified to be of interest to the user based on a positioning of a cursor over of the structural element.

6. The method of claim 1, wherein automatically modifying the structural element to include the first hyperlink includes modifying the structural element when the user stops navigating the document and maintains the structural element within a visible screen of the display device for a predetermined period of time.

7. The method of claim 1, further comprising displaying an Easter egg in response to the user performing a predetermined set of actions, and wherein instructions for the predetermined set of actions are displayed at the display device.

8. A method for modifying a presentation of hyperlinks in a document, comprising:
automatically inserting, using a processor, a first hyperlink into a first region of the document based on a first period of time of user engagement with the first region, the first region of the document displayed at a display device; and
automatically modifying a second hyperlink to disappear, using the processor, from a second region of the document based on a second period of time without user engagement, the second region separate and distanced from the first region by a threshold distance and also displayed at the display device.

9. The method of claim 8, wherein automatically inserting the first hyperlink includes configuring an appearance of the first hyperlink to be gradually modified, and wherein a gradual modification of the appearance of the first hyperlink includes one or more of changing a typeface, a color, a boldness, an underlining, and adding motion at the first hyperlink.

10. The method of claim 8, wherein automatically inserting the first hyperlink includes displaying a pop-up with the first hyperlink presented in the pop-up.

11. The method of claim 8, wherein automatically modifying the second hyperlink to disappear includes one or more of hiding the second hyperlink and removing the second hyperlink, and further includes configuring the second hyperlink to appear to fade away.

12. The method of claim 8, wherein the threshold distance is determined based on one of a number of characters between the first region and the second region and a percentage of each of a height and a width of a screen of the display device.

13. The method of claim 8, wherein each of automatically inserting the first hyperlink and automatically modifying the second hyperlink to disappear is executed based on a set of rules defined by a user.

14. A system for automatically modifying hyperlinks, comprising:
a document displayed at a display device; and
a processor, communicatively coupled to the display device and configured with executable instructions stored in non-transitory memory that, when executed, cause the processor to:
monitor a user's interaction with the document;
automatically insert a first hyperlink into a first region of the document based on a first period of time of user engagement with the first region;
automatically remove a second hyperlink from a second region of the document based on a second period of time without user engagement, the second region separate and distanced from the first region by a threshold distance; and
display the document at the display device with the first hyperlink visible and without the second hyperlink visible.

15. The system of claim 14, wherein the first hyperlink is automatically inserted and the second hyperlink is automatically removed based on a hyperlink generation engine configured with algorithms defining how hyperlinks are added and removed.

16. The system of claim 14, wherein the second hyperlink is automatically removed when a period of time elapses without user interaction with the second hyperlink, and wherein the period of time is monitored via a timer.

17. The system of claim 16, wherein the timer is one of invisible or displayed at a visible portion of the document at the display device.

18. The system of claim 14, wherein the first hyperlink is displayed by rotating the first hyperlink through a series of related anchors and corresponding destinations according to a predetermined passage of time.

19. The system of claim 14, wherein the first hyperlink is automatically inserted by adding the first hyperlink to an element around an image of the document or to at least one portion of the image, and wherein an appearance of the first hyperlink changes according to a predetermined time interval.

20. The system of claim 14, wherein the second hyperlink is hidden prior to being removed.
